(19) United States
(12) Patent Application Publication
(10) Pub. No.: US 2020/0329203 A1
(43) Pub. Date: Oct. 15, 2020

(54) SYSTEM AND METHOD FOR PANNING SHOT WITH IMAGE-STABILIZING FUNCTION

(71) Applicant: HEIMAVISTA INC., Taipei City (TW)

(72) Inventor: Ching-Kang LEE, Taipei City (TW)

(73) Assignee: HEIMAVISTA INC., Taipei City (TW)

(21) Appl. No.: 16/910,979

(22) Filed: Jun. 24, 2020

Related U.S. Application Data
(63) Continuation-in-part of application No. 16/212,389, filed on Dec. 6, 2018.

(51) Int. Cl. H04N 5/232; H04N 5/225; G06K 9/00

(52) U.S. Cl. CPC H04N 5/23299; H04N 5/23254; G06K 9/00624; H04N 5/2253

(57) ABSTRACT

A method for panning shot with an image-stabilizing function is adapted for having an image capturing direction of a panning shot dock to approach an optical signal source. The method comprises: receiving an optical positioning signal from the optical signal source by using an optical-signal receiving array, generating receiving strengths separately by using a plurality of optical-signal receiving units in the optical-signal receiving array; comparing the receiving strengths, and analyzing a position of the optical signal source of the optical positioning signal relative to the optical-signal receiving array according to the receiving strengths, to generate a first turning signal; and sending the first turning signal to control the panning shot dock, to enable the image capturing direction to approach the position of the optical signal source; finally, recognizing a feature object by the handheld mobile apparatus, and taking over the control over the panning shot dock.

### CROSS-REFERENCE TO RELATED APPLICATIONS

This patent application is a continuation-in-part application of non-provisional application Ser. No. 16/212,389 filed on Dec. 6, 2018, the disclosure of which is incorporated herein in its entirety by reference.

### BACKGROUND

### Technical Field

This disclosure relates to panning shot, and in particular, to a panning shot system with an image-stabilizing function and a method for image panning shot with an image-stabilizing function.

### Related Art

Currently, several panning shot technologies have been developed, in which a dock drives a smartphone to track a specific object. However, when the tracked object moves rapidly beyond a captured image, the smartphone cannot continue tracking due to the lack of a trackable object. Although some panning shot mechanisms have an object search mode, the object search mode is usually a blind search only, and as a result, a probability that a search fails is still high. In addition, if a tracking mechanism increases a tracking speed to prevent a tracked object from moving beyond a captured image, usually, excessive tracking occurs. The excessive tracking causes the smartphone to continuously swivel during photographing to track a specific object. As a result, a captured image (especially a dynamic video stream) is obviously shaky. Therefore, a tracking manner still needs to be improved.

### SUMMARY

In view of the problems, this disclosure proposes a panning shot system with an image-stabilizing function, including an optical tracker, a panning shot dock, and a handheld mobile apparatus.

The optical signal source includes an optical signal source configured to emit an optical positioning signal. The panning shot dock includes a control chip, a turning module, and an optical-signal receiving array. The turning module is electrically connected to the control chip, and an image capturing direction is defined on the turning module. The control chip is configured to control the turning module to turn, to change the image capturing direction. The optical-signal receiving array is electrically connected to the control chip, and rotates synchronously with the turning module. The optical-signal receiving array is configured to receive the optical positioning signal from the image capturing direction, generate a receiving strength distribution, and transfer the receiving strength distribution to the control chip. The handheld mobile apparatus is supported on the turning module, and establishes communications link with the panning shot dock. The handheld mobile apparatus includes a microprocessor and a camera. The camera is electrically connected to the microprocessor, and configured to capture a captured image in the image capturing direction and transfer the captured image to the microprocessor. The microprocessor defines a plurality of sampling frames having different sizes in the captured image, and loads one of the sampling frames in advance, and the microprocessor changes the loaded sampling frame according to a selection command.

Wherein the control chip compares the receiving strength distribution, and analyzes, according to the receiving strength distribution, an angle by which the image capturing direction needs to be changed, to generate a first turning signal and send the first turning signal to control the turning module to enable the image capturing direction to approach the position of the optical signal source.

Wherein the microprocessor recognizes a feature object in the captured image, when the feature object is recognized, the control chip stops sending the first turning signal; and when the feature object moves beyond the loaded sampling frame, the microprocessor sends a second turning signal to drive the turning module to change the image capturing direction, to enable the feature object to return into the sampling frame.

In at least one embodiment, the optical tracker further includes a first encoding circuit, configured to generate a designated identification code; wherein the first encoding circuit is configured to drive the optical signal source to emit the optical positioning signal according to the designated identification code, such that the optical positioning signal carries the designated identification code; and the control chip is configured to analyze whether the received optical positioning signal carries the designated identification code; wherein when the received optical positioning signal carries the designated identification code, the control chip compares the receiving strength distribution.

In at least one embodiment, the optical tracker further includes at least one first key, electrically connected to the first encoding circuit and configured to be pressed to trigger the first encoding circuit to drive the optical signal source to emit the optical positioning signal.

In at least one embodiment, when a plurality of feature objects is recognized, the microprocessor analyzes movements of the plurality of the feature objects and the optical signal source, to find out the feature object correlated with the optical signal source and keep the correlated feature object in the sampling frame.

In at least one embodiment, the first turning signal includes a turning direction and a turning angular velocity, and the turning angular velocity is correlated with the receiving strength distribution; wherein the more a peak of the receiving strength distribution occurs near an edge of the optical-signal receiving array, the higher the turning angular velocity is; wherein the more a peak of the receiving strength distribution occurs near a center of the optical-signal receiving array, the lower the turning angular velocity is.

This disclosure further proposes a method for image stabilizing panning shot with an image-stabilizing function, adapted for having an image capturing direction of a panning shot dock to approach an optical signal source, wherein the optical signal source is configured to emit an optical positioning signal.

The method for image stabilizing panning shot with an image-stabilizing function comprises: continuously capturing a captured image in the image capturing direction; receiving the optical positioning signal from the image capturing direction, and generating a receiving strength distribution; analyzing, according to the receiving strength distribution, an angle by which the image capturing direction needs to be changed, to generate a first turning signal; and sending the first turning signal to control the panning shot dock, to enable the image capturing direction to approach the position of the optical signal source; recognizing whether there is a feature object in the captured image; when the feature object is recognized, stopping sending the first turning signal; defining a sampling frame in the captured image; and when the feature object moves beyond the loaded sampling frame, sending a second turning signal to drive the panning shot dock to change the image capturing direction, to enable the feature object to return into the sampling frame.

In at least one embodiment, the method for image stabilizing panning shot with an image-stabilizing function further includes: before defining the sampling frame in the captured image defining a plurality of the sampling frames having different sizes in the captured image and loading one of the sampling frames in advance.

In at least one embodiment, the method for image stabilizing panning shot with an image-stabilizing function further includes: changing the loaded sampling frame according to a selection command.

In at least one embodiment, the method for image stabilizing panning shot with an image-stabilizing function further includes: before generating a first turning signal, analyzing whether the received optical positioning signal carries a designated identification code; wherein when the received optical positioning signal carries the designated identification code, comparing the receiving strength distribution

In this disclosure, an optical-code receiving array receives an optical positioning signal, so that a receiving angle can be effectively increased to avoid a search failure and ensure that a feature object that needs to be tracked is kept in a captured image. Moreover, in at least one embodiment, a sampling frame may be set rapidly, so that excessive tracking can be avoided, and the problem that the captured image is unstable and shaky is resolved.

### BRIEF DESCRIPTION OF THE DRAWINGS

FIG. 1 is a schematic system diagram of a panning shot system with an image-stabilizing function according to a first embodiment of this disclosure.

FIG. 2 is a circuit block diagram of a remote control apparatus and a panning shot dock according to the first embodiment of this disclosure.

FIG. 3 is a schematic diagram of a threshold group of a plurality of optical-signal receiving units in an optical-signal receiving array according to the first embodiment of this disclosure.

FIG. 4 to FIG. 9 show optical-signal receiving arrays in different array types according to the first embodiment of this disclosure.

FIG. 10 is a circuit block diagram of a handheld mobile apparatus and a panning shot dock according to the first embodiment of this disclosure;

FIG. 11 is a schematic diagram of a plurality of sampling frames and a selection list in a sampling image according to an embodiment of this disclosure.

FIG. 12 and FIG. 13 are schematic diagrams of tracking an optical signal source according to the first embodiment of this disclosure.

FIG. 14 and FIG. 15 are schematic diagrams of keeping a feature object in a sampling frame according to the first embodiment of this disclosure;

FIG. 16 is a schematic diagram of tracking a plurality of feature objects according to the first embodiment of this disclosure;

FIG. 17 is a circuit block diagram of an optical tracker, a remote control apparatus and a panning shot dock according to a second embodiment of this disclosure.

FIG. 18 is a flowchart of a method for image stabilizing panning shot with an image-stabilizing function according to this disclosure.

FIG. 19 is another flowchart of a method for image stabilizing panning shot with an image-stabilizing function according to this disclosure.

### DETAILED DESCRIPTION

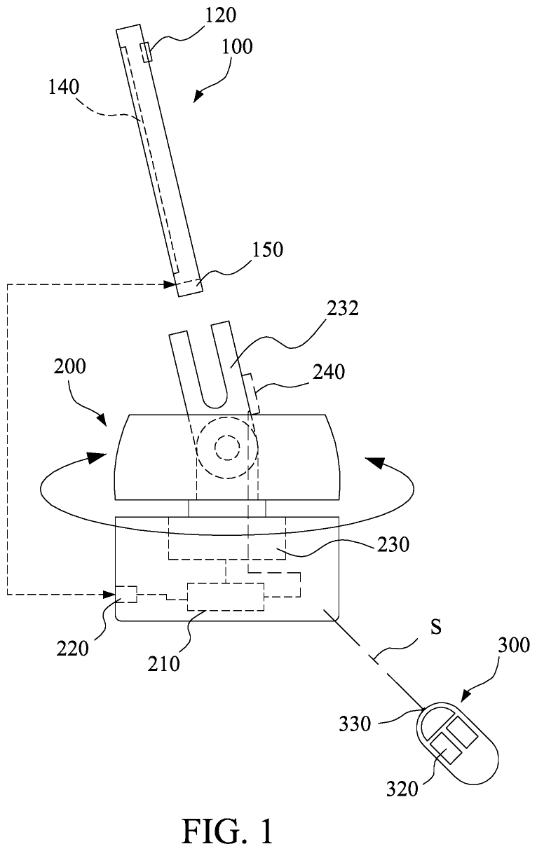

Referring to FIG. 1, a panning shot system with an image-stabilizing function disclosed in a first embodiment of this disclosure is configured to perform a method for panning shot with an image-stabilizing function. The panning shot system with an image-stabilizing function includes a panning shot dock 200 and a remote control apparatus 300. The panning shot dock 200 has a changeable image capturing direction. A handheld mobile apparatus 100 is supported on the panning shot dock 200, and is configured to capture a captured image M in the image capturing direction. The handheld mobile apparatus 100 may control the panning shot dock 200 to rotate to change the image capturing direction of the handheld mobile apparatus 100, to continuously track a feature object A. The panning shot dock 200 may automatically change the image capturing direction, to enable the image capturing direction to approach the remote control apparatus 300. That is, the panning shot dock 200 may automatically search for the remote control apparatus 300, to have the image capturing direction of the handheld mobile apparatus 100 to approach the remote control apparatus 300. The handheld mobile apparatus 100 may recognize the feature object A, to further control the panning shot dock 200 to keep the feature object A in a specified range in the captured image M.

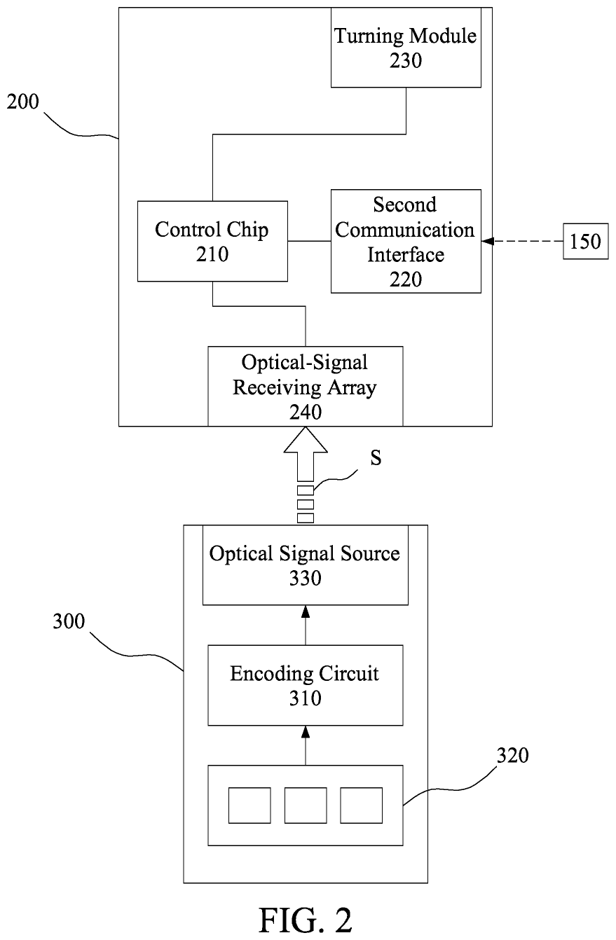

As shown in FIG. 1 and FIG. 2, the remote control apparatus 300 has an encoding circuit 310, an optical signal source 330, and a key group 320.

The encoding circuit 310 is configured to generate a designated identification code. The optical signal source 330 is electrically connected to the encoding circuit 310. The encoding circuit 310 is also configured to drive the optical signal source 330 to emit the optical positioning signal S according to the designated identification code, such that the optical positioning signal S carries the designated identification code. In one specific embodiment, the optical signal source 330 may be a single optical-code transmission unit or an optical-code transmission array. The key group 320 is electrically connected to the encoding circuit 310, and is configured to be pressed to trigger the encoding circuit 310 to drive the optical signal source 330 to emit the optical positioning signal S for the panning shot dock 200 to perform tracking.

As shown in FIG. 1 and FIG. 2, the panning shot dock 200 includes a control chip 210, a second communication interface 220, a turning module 230, and an optical-signal receiving array 240.

As shown in FIG. 1 and FIG. 2, the second communication interface 220 is electrically connected to the control chip 210, and establishes a communications link with a first communication interface 150 of the handheld mobile apparatus 100, so that the control chip 210 of the panning shot dock 200 establishes a communications link with the handheld mobile apparatus 100 to receive a second turning signal sent from the handheld mobile apparatus 100 and transfer the second turning signal to the control chip 210.

As shown in FIG. 1 and FIG. 2, the turning module 230 is electrically connected to the control chip 210, and the turning module 230 defines the image capturing direction. At the same time, the turning module 230 is configured to support the handheld mobile apparatus 100, so that the handheld mobile apparatus 100 may capture the captured image M in the image capturing direction. The control chip 210 drives the turning module 230 according to the second turning signal or a first turning signal to turn to change the image capturing direction, so as to change a range covered by the captured image M.

The turning module 230 usually includes one or more motors, a necessary gear box, and a fixture 232. The fixture 232 is configured to hold the handheld mobile apparatus 100, so as to support the handheld mobile apparatus 100 on the turning module 230.

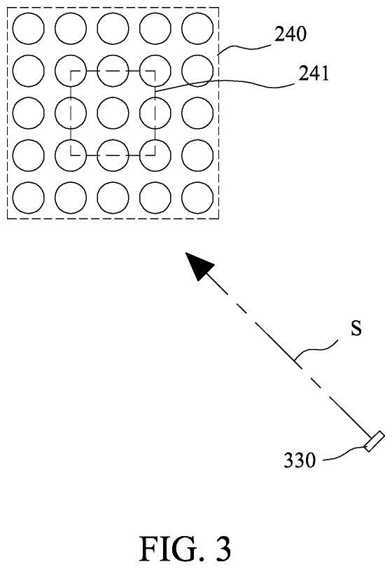

As shown in FIG. 1, FIG. 2, and FIG. 3, the optical-signal receiving array 240 is electrically connected to the control chip 210, and rotates synchronously with the turning module 230, especially, rotates synchronously with the fixture 232. The optical-signal receiving array 240 has a plurality of optical-signal receiving units, configured to receive the optical positioning signal S, and generate different receiving strengths according to respective different receiving distances and angles, to generate a receiving strength distribution and transfer the receiving strength distribution to the control chip 210. Generally, a receiving strength is stronger as an angle of incidence of the optical positioning signal S to an optical-signal receiving unit approaches 90 degrees. The control chip 210 is configured to analyze whether the received optical positioning signal S carries the designated identification code. When the received optical positioning signal S carries the designated identification code, the control chip 210 compares the receiving strength distribution, analyzes, according to the receiving strength distribution, an angle by which the image capturing direction needs to be changed, to generate a first turning signal, and sends the first turning signal to control the turning module 230, to enable the image capturing direction to approach a position of the optical signal source 330. Therefore, the captured image M of the handheld mobile apparatus 100 has a chance of covering an object that carries the remote control apparatus 300.

The first turning signal includes a turning direction and a turning angular velocity. The turning angular velocity is correlated with the receiving strength distribution. The more a peak of the receiving strength distribution occurs near an edge of the optical-signal receiving array 240, the higher the turning angular velocity is. Otherwise, the more a peak of the receiving strength distribution occurs near a center of the optical-signal receiving array 240, the lower the turning angular velocity is.

As shown in FIG. 3, a manner of analyzing, according to the receiving strength distribution, an angle by which the image capturing direction needs to be changed is as follows.

A threshold group 241 may be defined in a central area of the optical-signal receiving array 240. It is set that receiving strengths of optical-signal receiving units in the threshold group 241 are required to exceed a threshold to obtain a required receiving strength distribution. That is, the image capturing direction defined by the turning module 230 at this time approaches the optical signal source 330 of the remote control apparatus 300. If a receiving strength of at least one optical-signal receiving unit in the threshold group 241 does not reach the threshold, the optical-signal receiving array 240 is turned (that is, the turning module 230 is turned) to a direction having a relatively high receiving strength according to a position of the optical-signal receiving unit in the optical-signal receiving array 240 and receiving strengths of the other optical-signal receiving units, until the receiving strengths of all of the optical-signal receiving units in the threshold group 241 reach the threshold. A size of a range of the threshold group 241 is related to sensitivity. A smaller range of the threshold group 241 indicates a higher sensitivity, that is, the image capturing direction is closer to the optical signal source 330.

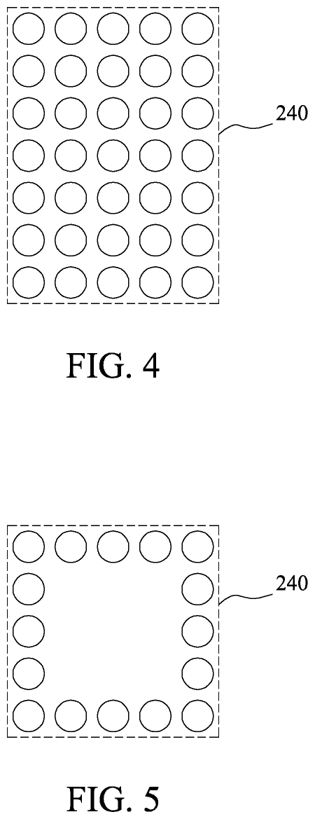

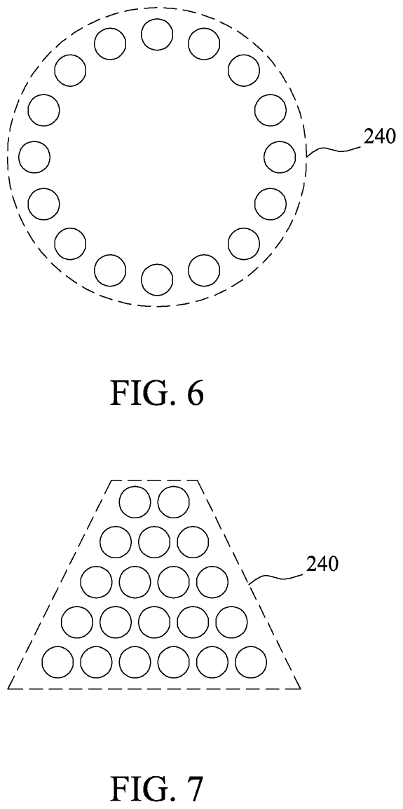

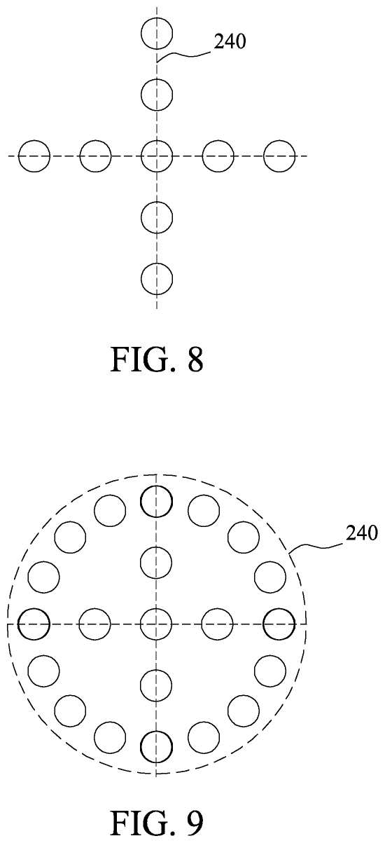

As shown in FIG. 4 to FIG. 9, a square array arranged in a plane in FIG. 3 is only an example. An array type of the optical-signal receiving array 240 may be a rectangular array, an annular array (including a circular array and a polygonal frame), a trapezoidal array (include a triangular array), a cross-shaped array, and a combination thereof, and the optical-signal receiving array 240 may be arranged on a curved surface to increase a receiving angle. The fixture 232 for fixing the optical-signal receiving array 240 on the turning module 230 in FIG. 3 is also an example, and other examples may be used provided that a receiving surface of the optical-signal receiving array 240 can rotate synchronously along with the image capturing direction defined by the turning module 230.

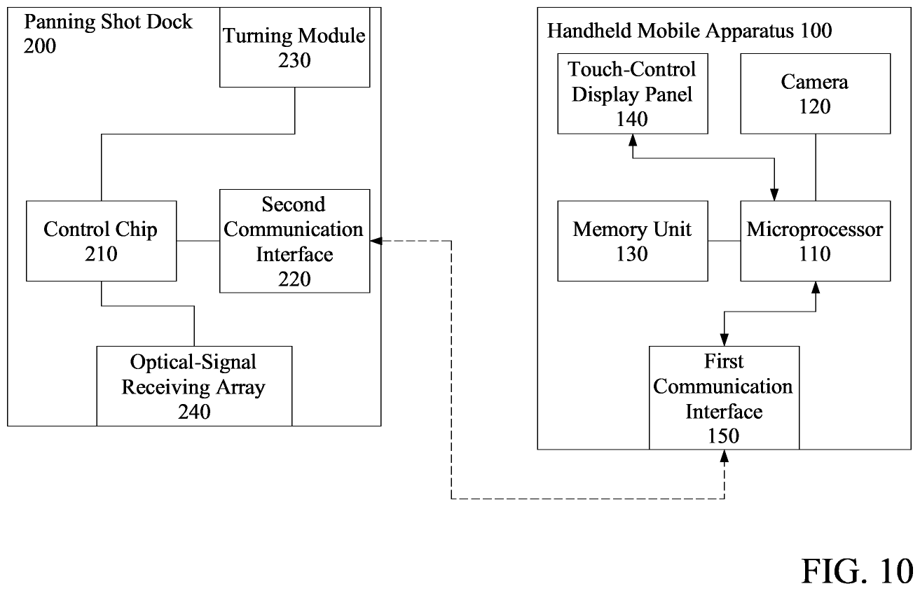

Referring to FIG. 1 and FIG. 10, the handheld mobile apparatus 100 of this disclosure may be an electronic apparatus such as a smartphone or a tablet computer that has a capturing function and a video recording function and may establish a communications link with the panning shot dock 200.

As shown in FIG. 1 and FIG. 10, the handheld mobile apparatus 100 is supported on the turning module 230, and includes a microprocessor 110, a camera 120, a memory unit 130, a touch-control display panel 140, and the first communication interface 150.

As shown in FIG. 1 and FIG. 10, the camera 120, the memory unit 130, and the touch-control display panel 140 are electrically connected to the microprocessor 110. The camera 120 is configured to capture the captured image M in the image capturing direction and transfer the captured image M to the microprocessor 110, to transmit the captured image M to the memory unit 130 and store the captured image M.

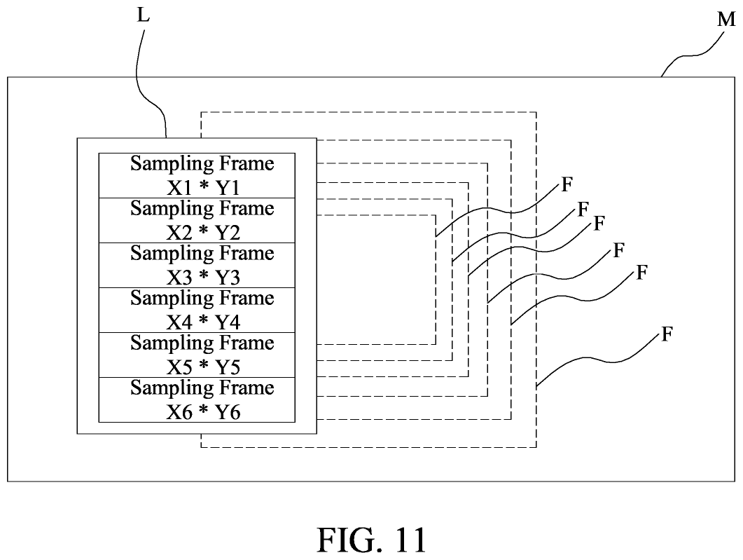

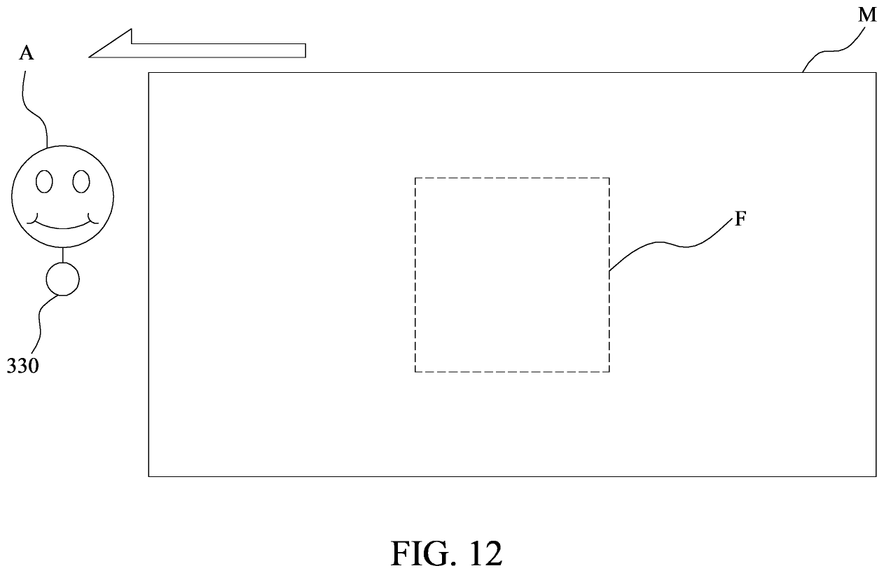

As shown in FIG. 10 and FIG. 11, the microprocessor 110 defines a plurality of sampling frames F having different sizes in the captured image M, and loads one of the sampling frames F in advance.

As shown in FIG. 10, the memory unit 130 is configured to store, in addition to the captured image M, an operating system and a necessary photography application program, and the memory unit 130 stores set values of the sampling frame F to be loaded by the microprocessor 110 to perform an object tracking mode.

As shown in FIG. 10 and FIG. 11, the touch-control display panel 140 is electrically connected to the microprocessor 110, and is configured to display a captured image M, receive a touch control operation, and feedback the touch control operation to the microprocessor 110.

As shown in FIG. 10 and FIG. 11, the microprocessor 110 may change the loaded sampling frame F according to the selection command. A manner of inputting the selection command may be shown in FIG. 11. An independent selection list L or a selection list L that pops up in the captured image M is displayed, and options of the sampling frames F having different sizes in ascending order are displayed, so that a user chooses a sampling frame in the touch-control display panel 140.

As shown in FIG. 1 and FIG. 10, the first communication interface 150 is electrically connected to the microprocessor 110, and is configured to establish a communications link. The first communication interface 150 may be a wired communication interface, for example, a USB interface, or may be a wireless communication interface, for example, Bluetooth, an RF communication interface, and a Wi-Fi interface (supporting Wi-Fi Direct).

As shown in FIG. 1, FIG. 2, and FIG. 10, different keys in the key group 320 are configured to trigger the encoding circuit 310 to send other optical-code signals of turning on or off a capturing function, enabling or disabling a tracking mode, triggering a shutter for capturing a single photo, or performing another operation. The other optical-code signals are received by the panning shot dock 200, and are then transferred to the handheld mobile apparatus 100 through the first communication interface 150 and the second communication interface 220, so that related functions of the handheld mobile apparatus 100 are performed by using the remote control apparatus 300. Moreover, the selection command is not necessarily generated by the touch-control display panel 140, the encoding circuit 310 may pre-store a plurality of sequence numbers, and each sequence number corresponds to one sampling frame F. Choosing commands or sequence numbers of different sampling frames F may be sent cyclically by continuously pressing keys in the key group 320, to enable the handheld mobile apparatus 100 to load the corresponding sampling frames F.

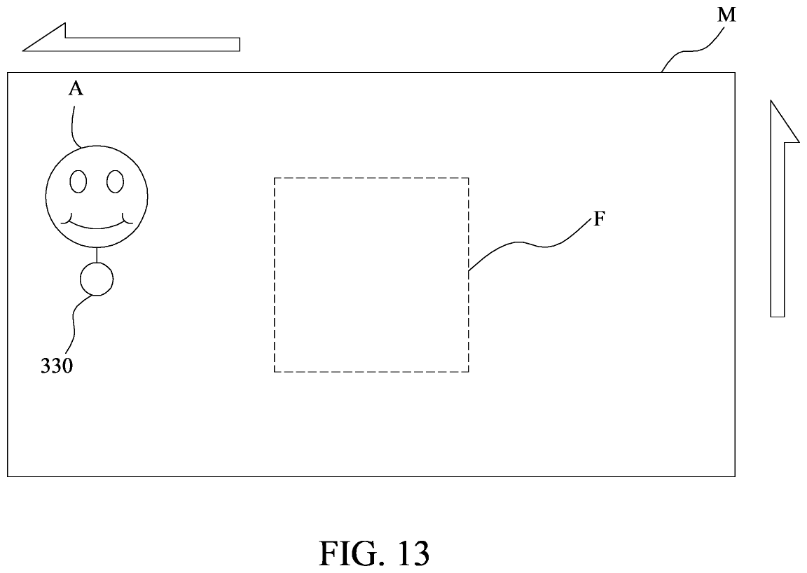

As shown in FIG. 12 and FIG. 13, the optical signal source 330 is disposed together with the feature object A. when the image capturing direction approaches the optical signal source 330, the feature object A usually enters the captured image M, and the microprocessor 110 is able to recognize the feature object A in the captured image M.

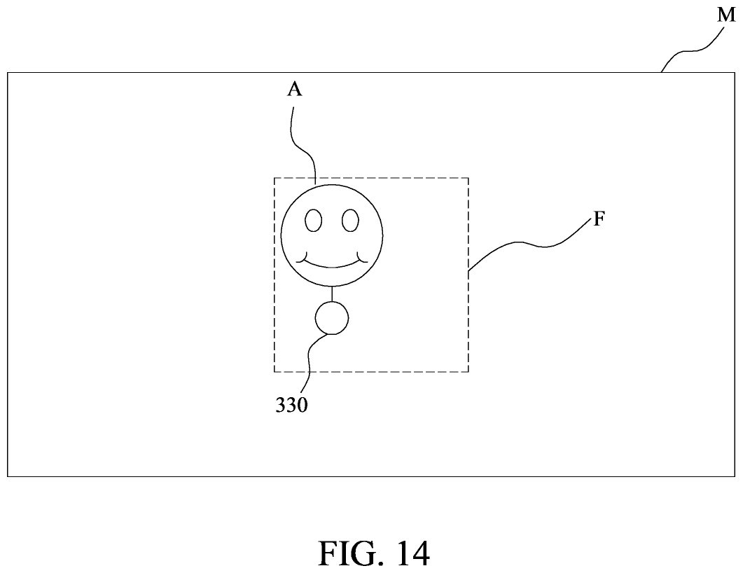

As shown in FIG. 13 and FIG. 14, when the microprocessor 110 recognizes the feature object A in the captured image M, the handheld mobile apparatus 100 enables the object tracking mode, the microprocessor 110 loads one of the sampling frames F in advance, and continuously recognizes the feature object A. The microprocessor 110 also sends an interrupt signal to stop the control chip 210 generating the first turning signal. At this time, the handheld mobile apparatus 100 takes over the control over the turning module 230. When the feature object A moves beyond the loaded sampling frame F, the microprocessor 110 sends a second turning signal to drive the turning module 230 to change the image capturing direction, to enable the feature object A to return into the sampling frame F.

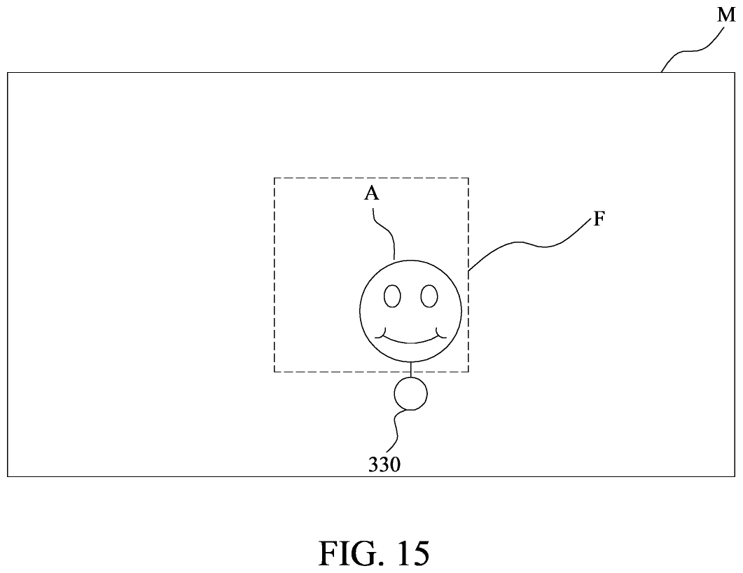

As shown in FIG. 15, if the feature object A keeps moving in the captured image M while keeping staying in the sampling frame F, the image capturing direction does not change. In this way, compared with a manner of continuously tracking the feature object A, the captured image M in the first embodiment of this disclosure may be kept relatively stable, and an image capturing direction is changed only when the feature object A displaces by a large distance.

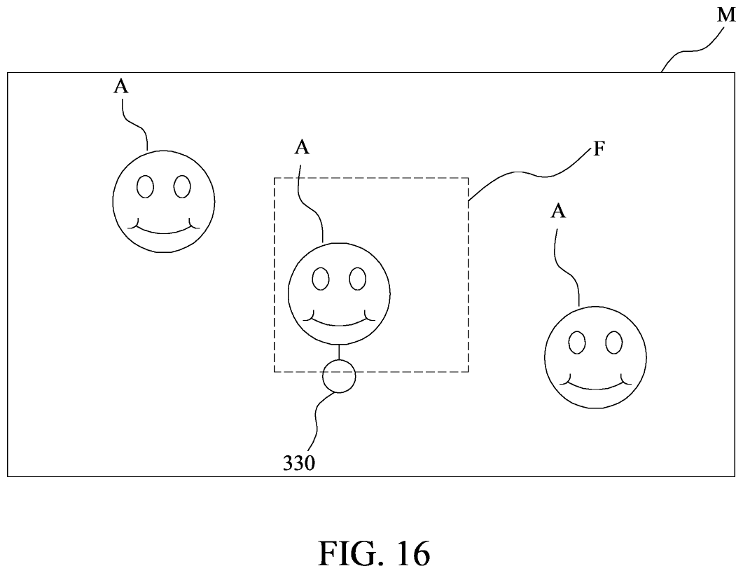

As shown in FIG. 16, in a scene with many people, the face of each person is recognized as a feature object A, so that the microprocessor 110 recognizes a plurality of feature objects A at the same time. At this time, the microprocessor 110 analyzes movements of the plurality of the feature objects A and the optical signal source 330, to find out the feature object A correlated with the optical signal source 330, for example the face of the user who carries the remote control apparatus 300 (the optical signal source 330), and then keeps this feature object A in the sampling frame F.

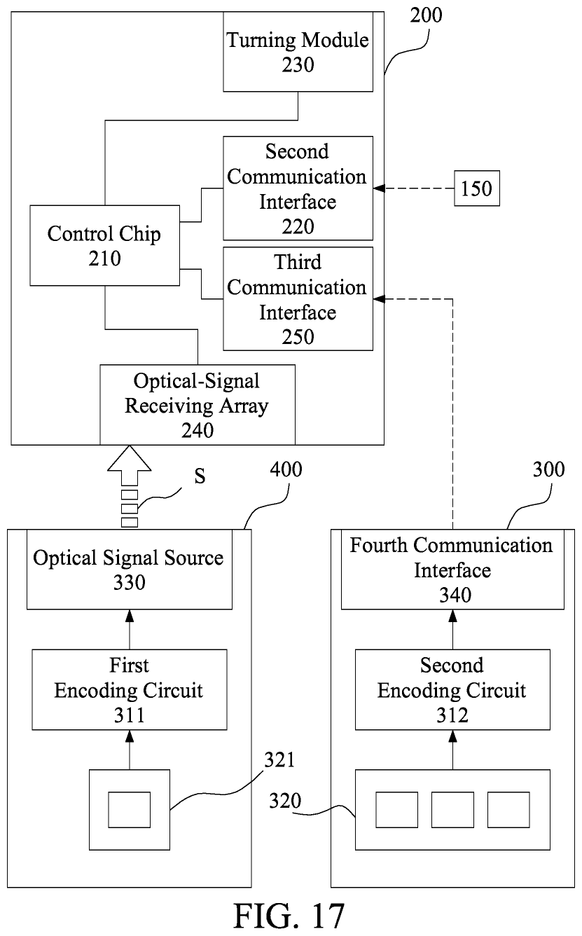

As shown in FIG. 17, which illustrates a circuit block diagram of an optical tracker, a remote control apparatus and a panning shot dock according to a second embodiment of this disclosure. In the second embodiment, the components for emitting the optical positioning signal S are separated from the remote control apparatus 300, to form the independent optical tracker 400 Similarly, the encoding circuit 310 as disclosed in the first embodiment is divided into a first encoding circuit 311 and a second encoding circuit 312 in this embodiment.

As shown in FIG. 17, the optical signal source 400 includes an optical signal source 300, a first encoding circuit 311, and at least one first key 321. The optical signal source 330 is configured to send an optical positioning signal S. The first encoding circuit 311 is configured to generate a designated identification code and configured to drive the optical signal source 330 to emit the optical positioning signal S according to the designated identification code, such that the optical positioning signal S carries the designated identification code. The at least one first key 321 is electrically connected to the first encoding circuit 311, and configured to be pressed to trigger the first encoding circuit 311 to drive the optical signal source 330 to emit the optical positioning signal S. That is, the remote control apparatus 300 is not required to be equipped with the function for emitting the optical positioning signal S. The panning shot dock 200 may automatically change the image capturing direction, to enable the image capturing direction to approach the optical tracker 400.

As shown in FIG. 17, in the second embodiment, the panning shot dock 200 and the remote control apparatus 300 are modified. In the second embodiment, the panning shot dock 200 further includes a third communication interface 250, electrically connected to the control chip 210. The remote control apparatus 300 further includes a fourth communication interface 340, electrically connected to the second encoding circuit 312. The third communication interface 250 and the fourth communication interface 340 are configured to establish a communications link with each other. The third communication interface 250 and the fourth communication interface 340 may be wireless communication interfaces, Bluetooth, an RF communication interfaces, and a Wi-Fi interfaces (supporting Wi-Fi Direct) Specifically, The communications links between third communication interface 250 and the fourth communication interface 340 and between first communication interface 150 and the second communication interface 220 adopt different communication protocols.

As shown in FIG. 17, different keys in the key group 320 are configured to trigger the encoding circuit 310 to send function command code signals of turning on or off a capturing function, enabling or disabling a tracking mode, triggering a shutter for capturing a single photo, or performing another operation, through the fourth communication interface 340.

The function command code signals are received by the panning shot dock 200 via the third communication interface 250. Then the function command code signals are transferred to the handheld mobile apparatus 100 through the first communication interface 150 and the second communication interface 220, so that related functions of the handheld mobile apparatus 100 are performed by using the remote control apparatus 300. Moreover, the selection command is not necessarily generated by the touch-control display panel 140, the second encoding circuit 312 may pre-store a plurality of sequence numbers, and each sequence number corresponds to one sampling frame F. Choosing commands or sequence numbers of different sampling frames F may be sent cyclically by continuously pressing keys in the key group 320, to enable the handheld mobile apparatus 100 to load the corresponding sampling frames F. That is, when the optical tracker 400 is separated to form an independent device, the remote control apparatus 300 is no longer adapted to trigger and generate the optical positioning signal S.

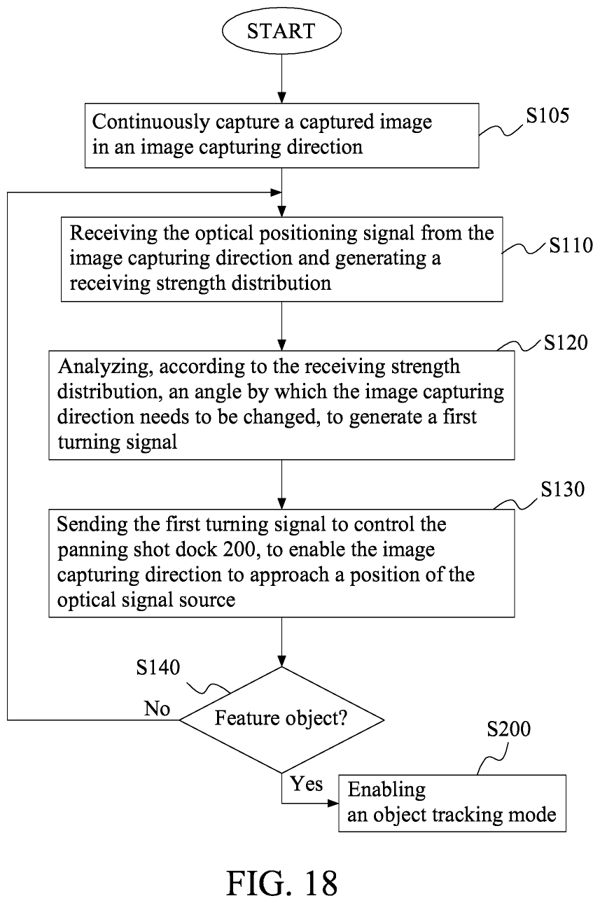

As shown in FIG. 18, a method for panning shot with an image-stabilizing function of this disclosure is adapted for having an image capturing direction of a panning shot dock 200 to approach an optical signal source 330. The optical signal source 330 is configured to send an optical positioning signal S. The method includes the following steps.

The microprocessor 110 enables the camera 120 to continuously capture a captured image M in an image capturing direction and transfer the captured image M to the microprocessor 110, as illustrated in step S105.

The optical positioning signal S is received by using an optical-signal receiving array 240 from the image capturing direction, and a receiving strength distribution is generated, as illustrated in step S110.

A control chip 210 analyzes, according to the receiving strength distribution, an angle by which the image capturing direction needs to be changed, to generate a first turning signal, as illustrated in step S120.

The control chip 210 sends the first turning signal to control the panning shot dock 200, to enable the image capturing direction to approach a position of the optical signal source 330, as illustrated in step S130.

The microprocessor recognizes whether there is a feature object A in the captured image, as illustrated in step S140.

As discussed above, when the image capturing direction approaches the optical signal source 330, a feature object A usually enters a captured image M. At this time, the microprocessor 110 recognizes the feature object A in the captured image M, and the handheld mobile apparatus 100 enables an object tracking mode, as illustrated in step S200.

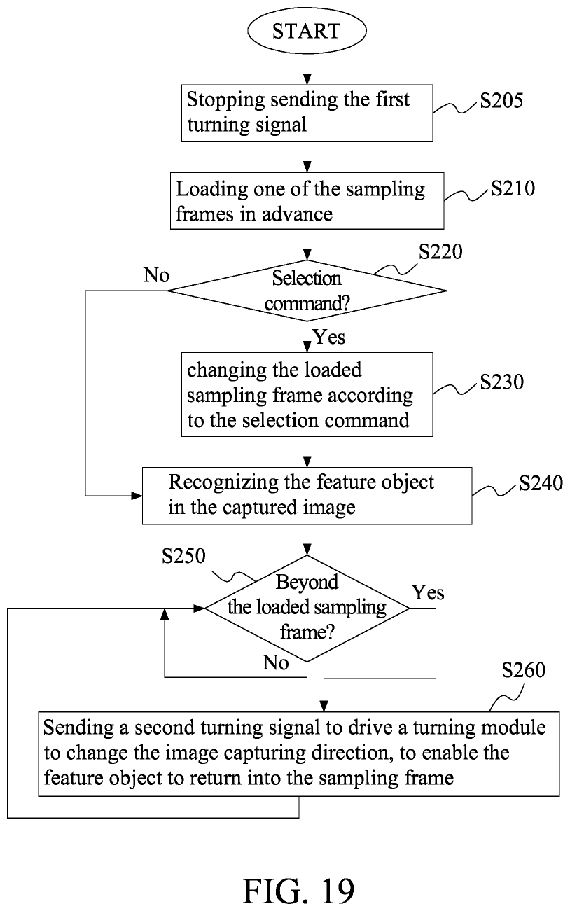

As shown in FIG. 19, after the handheld mobile apparatus 100 enables the object tracking mode, via the communication link the microprocessor 110 controls the control chip 210 to stop sending the first turning signal, so as to stop the function of tracking the optical signal source 330 by the panning shot dock 200, as shown in Step 205.

The handheld mobile apparatus 100 defines a plurality of sampling frames F having different sizes in the captured image M, and loads one of the sampling frames F in advance, as illustrated in step S210. If a selection command is input, the loaded sampling frame F is changed according to the selection command, as shown in steps S220 and S230.

The feature object A is recognized in the captured image M, as shown in step S240. When the feature object A moves beyond the loaded sampling frame F, the handheld mobile apparatus 100 sends a second turning signal to drive a turning module 230 to change the image capturing direction, to enable the feature object A to return into the sampling frame F, as shown in steps S250 and S260.

Similarly, when a plurality of feature objects A are recognized in step S240, the microprocessor 110 analyzes movements of the plurality of the feature objects A and the optical signal source 330, to find out the feature object A correlated with the optical signal source 330, for example the face of the user who carries the remote control apparatus 300 (the optical signal source 330), Alternatively, the microprocessor 110 may adjust a scale to keep all the feature objects A in the sampling frame F, Alternatively, the microprocessor 110 keeps a chosen feature object A in the sampling frame according to a choosing command.

In this disclosure, an optical-code receiving array receives an optical positioning signal S, so that a receiving angle can be effectively increased to avoid a search failure and ensure that a feature object A that needs to be tracked is kept in a captured image M. A sampling frame F may be set rapidly, so that excessive tracking can be avoided, and the problem that the captured image M is unstable and shaky is resolved.

What is claimed is:

1. A panning shot system with an image-stabilizing function, comprising:
an optical tracker, including an optical signal source configured to emit an optical positioning signal;
a panning shot dock, comprising:
a control chip;
a turning module, electrically connected to the control chip; wherein an image capturing direction is defined on the turning module, and the control chip is configured to control the turning module to turn, to change the image capturing direction; and
an optical-signal receiving array, electrically connected to the control chip, and rotating synchronously with the turning module; wherein the optical-signal receiving array is configured to receive the optical positioning signal from the image capturing direction, generate a receiving strength distribution, and transfer the receiving strength distribution to the control chip; and
a handheld mobile apparatus, supported on the turning module, and establishing communications link with the panning shot dock, wherein the handheld mobile apparatus comprises:
a microprocessor; and
a camera, electrically connected to the microprocessor, and configured to capture a captured image in the image capturing direction and transfer the captured image to the microprocessor; wherein the microprocessor defines a plurality of sampling frames having different sizes in the captured image, and loads one of the sampling frames in advance, and the microprocessor changes the loaded sampling frame according to a selection command;
wherein the control chip compares the receiving strength distribution, analyzing, according to the receiving strength distribution, an angle by which the image capturing direction needs to be changed, to generate a first turning signal, and sends the first turning signal to control the turning module to enable the image capturing direction to approach a position of the optical signal source; and
wherein the microprocessor recognizes a feature object in the captured image, when the feature object is recognized, the control chip stops sending the first turning signal; and
when the feature object moves beyond the loaded sampling frame, the microprocessor sends a second turning signal to drive the turning module to change the image capturing direction, to enable the feature object to return into the sampling frame.

2. The panning shot system with an image-stabilizing function according to claim 1, wherein the optical tracker further includes:
a first encoding circuit, configured to generate a designated identification code;
wherein the first encoding circuit is configured to drive the optical signal source to emit the optical positioning signal according to the designated identification code, such that the optical positioning signal carries the designated identification code;
wherein the control chip is configured to analyze whether the received optical positioning signal carries the designated identification code; wherein when the received optical positioning signal carries the designated identification code, the control chip compares the receiving strength distribution.

3. The panning shot system with an image-stabilizing function according to claim 2, wherein the optical tracker further includes:
at least one first key, electrically connected to the first encoding circuit, and configured to be pressed to trigger the first encoding circuit to drive the optical signal source to emit the optical positioning signal.

4. The panning shot system with an image-stabilizing function according to claim 1, wherein when a plurality of feature objects is recognized, the microprocessor analyzes movements of the plurality of the feature objects and the optical signal source, to find out the feature object correlated with the optical signal source and keep the correlated feature object in the sampling frame.

5. The panning shot system with an image-stabilizing function according to claim 1, wherein the first turning signal includes:
a turning direction; and
a turning angular velocity, correlated with the receiving strength distribution;
wherein the more a peak of the receiving strength distribution occurs near an edge of the optical-signal receiving array, the higher the turning angular velocity is; and the more the peak of the receiving strength distribution occurs near a center of the optical-signal receiving array, the lower the turning angular velocity is.

6. A method for image stabilizing panning shot with an image-stabilizing function adapted for having an image capturing direction of a panning shot dock to approach an optical signal source, wherein the optical signal source is configured to emit an optical positioning signal; the method comprising:
continuously capturing a captured image in the image capturing direction;
receiving the optical positioning signal from the image capturing direction, and generating a receiving strength distribution;
analyzing, according to the receiving strength distribution, an angle by which the image capturing direction needs to be changed, to generate a first turning signal; and
sending the first turning signal to control the panning shot dock, to enable the image capturing direction to approach a position of the optical signal source;
recognizing whether there is a feature object in the captured image; when the feature object is recognized, stopping sending the first turning signal;
defining a sampling frame in the captured image; and
when the feature object moves beyond the loaded sampling frame, sending a second turning signal to drive the panning shot dock to change the image capturing direction, to enable the feature object to return into the sampling frame.

7. The method for image stabilizing panning shot with an image-stabilizing function according to claim 6, further comprising:
before defining the sampling frame in the captured image, defining a plurality of the sampling frames having different sizes in the captured image and loading one of the sampling frames in advance.

8. The method for image stabilizing panning shot with an image-stabilizing function according to claim 7, further comprising:
changing the loaded sampling frame according to a selection command.

9. The method for image stabilizing panning shot with an image-stabilizing function according to claim 6, further comprising:
before generating a first turning signal, analyzing whether the received optical positioning signal carries a designated identification code, and when the received optical positioning signal carries the designated identification code comparing the receiving strength distribution.
